(19) United States
(12) Patent Application Publication
(10) Pub. No.: US 2010/0147116 A1
(43) Pub. Date: Jun. 17, 2010

(54) Firefighter Tool

(76) Inventors: Darren Fenton, West Hempstead, NY (US); Jim Bullock, Rockaway Park, NY (US); Greg Chero, Babylon, NY (US)

Correspondence Address: Albert Cefalo, 36 Middle Rd., Sudbury, MA, 01776, US

(21) Appl. No.: 12/335,240

(22) Filed: Dec. 15, 2008

(51) Int. Cl. B25B 13/04

(52) U.S. Cl. 81/120

(57) ABSTRACT

A firefighter's tool for opening a standpipe cap comprising a base having slots at one end to engage the pins on a cap and having a head member on the end opposite to the slots to engage with a wrench or ratchet.

### BACKGROUND OF THE INVENTION

1. Field of the Invention

This invention relates to hand tools for use by firefighters.

2. Description of the Prior Art

In the fire service the firefighter is required to carry a myriad of tools in order to perform his/her duties on the fire ground. For example, as disclosed in U.S. Pat. No. 6,298,754, the firefighter's tool bag may include, among other things a pipe wrench for operating a valve stems and a spanner wrench for operating pipe caps and hose coupling rings, which caps and rings generally have circumferentially arranged pins to which the spanner wrench engages to spin the cap or hose ring.

One particular operation is that of high rise fires. When confronted with a fire on an upper floor of a high rise building the firefighter typically will bring a hose and tools to the fire floor in order to extinguish the fire. In high rise buildings, water is typically provided for the fire fighter by means of standpipe. A standpipe is a pipe running from the ground to the roof allowing water to reach upper floors. In general, each floor of the high rise includes at least one such standpipe such that the firefighter may have water at that floor to charge the firefighter's hose to fight the fire. Attached to the standpipe is an outlet with a valve enabling firefighters to turn on and off the water. Also attached to the outlet is a cap, see FIG. 1. The purpose of this cap is to protect the threads of the standpipe as the firefighter's hose will connect to this standpipe water supply through these threads. The cap also serves to prevent debris from entering the standpipe system.

The purpose of the cap as indicated above is apparent; however it can lead to serious problems and a dangerous situation during a fire if the cap cannot be readily, easily or quickly removed. While conventional tools will remove a cap under normal circumstances, they do not work as efficiently with the more difficult to remove caps. For, example, over time the cap may become stuck do to corrosion, over tightening rust or the like. In addition some standpipe outlets are located in a recessed cabinet, which reduces the range of motion to remove the cap. Furthermore, the pins of the cap may have been aligned such that the firefighter's tools do not readily engage the pins to rapidly remove the cap. In these situations, the conventional tools may be just cumbersome or counterproductive. It is apparent that the extra time involved in removing a stuck or inaccessible cap can lead to a more dangerous situation to the firefighters and the occupants of the building and to more damage to the building as the fire is not being addressed because the firefighters are struggling to obtain access to the standpipe water supply.

### SUMMARY OF THE INVENTION

According to the invention, a firefighter's tool a base having slots at one end to engage the pins on a cap and having a head member on the end opposite to the slots to engage with a wrench. The head member may be shaped with four or more sides, similar to a conventional bolt-nut or it may include a slot disposed within the head member, or both, to be engaged by a socket wrench, square drive, hex-drive or the like.

In a preferred embodiment, the tool includes a cylindrical base one end of the cylindrical base having at least two slots for engaging the pins on a standpipe cap. On the other end of the cylindrical base is disposed a head member having multiple sides for engagement by a wrench, including an adjustable wrench, such as a pipe wrench. Further, included in the head member are side portions defining a slot disposed in the head member to be engaged by a socket wrench ratchet drive or a correspondingly sized “Allen Wrench”.

In a further embodiment of the invention, as the cap pins may be spaced circumferentially about the cap at various angular locations, the base member includes multiple slots spaced to accommodate such various cap-pin locations. For example, it is common to have only two pins spaced 180 degrees apart, whereas it is also known to have three pins spaced 120 degrees apart. Such variable pin locations may be accommodated by including multiple slots in the base to engage the two pin situation as well as the three pin situation or other pin locations.

### BRIEF DESCRIPTION OF THE DRAWINGS

FIG. 1 is a perspective view of one type of standpipe cap.

FIG. 2 is a schematic of a preferred embodiment of the tool of the invention, in perspective.

FIG. 3 is a view of the tool of the invention shown in FIG. 2 in the direction shown by arrows 3 of FIG. 2.

### DETAILED DESCRIPTION OF THE INVENTION

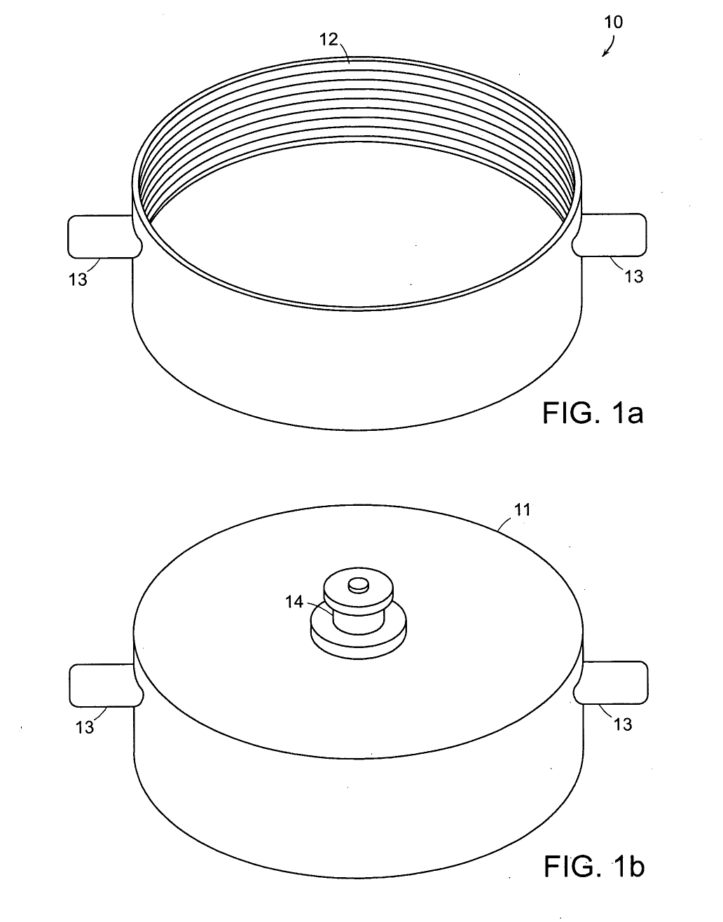

FIG. 1 is a perspective view of one type of standpipe cap 10 comprising a cover 11, internal screw threads 12 to engage the standpipe (not shown) and pins 13. The cap 10 is typically threaded to the standpipe to protect the standpipe threads where the hose will be connected and to protect debris from entering the standpipe system.

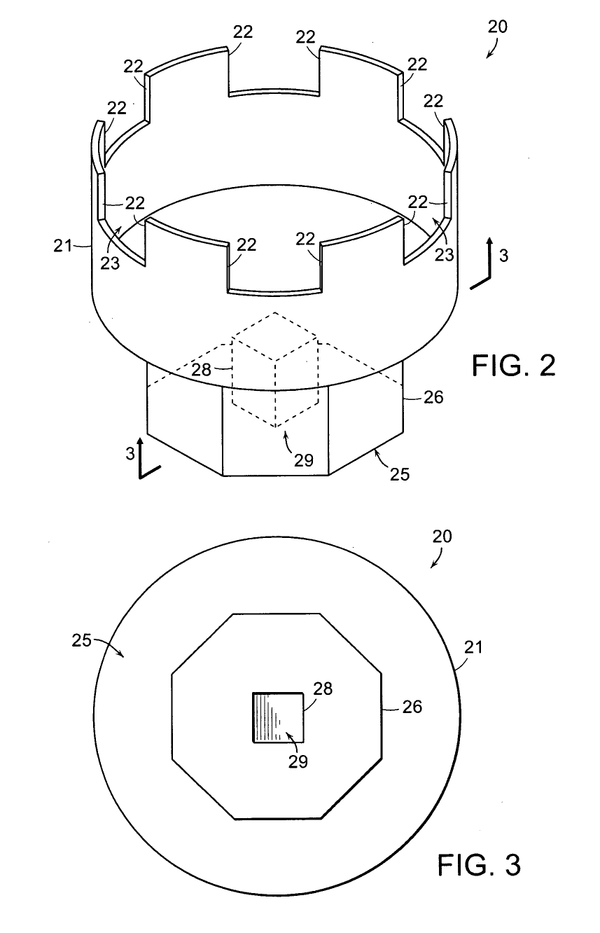

FIG. 2 is a schematic of the firefighter tool 20 to engage the standpipe cap 10. The tool includes a base 21, in the embodiment shown in FIG. 2 the base is a cylindrical shape to engage the cap 10. The base 21 further includes side members 22 forming at least two slots 23 arranged about the base 21 to cooperatively engage the pins 13 of the cap 10. The base member further includes a head member 25 disposed at the other end of the base opposite the side members 22 forming the pin engaging slots.

The head member may be shaped with multiple side walls 26 for engagement by a wrench, including an adjustable wrench. In the embodiment shown in FIGS. 2 and 3 the head member 25 includes eight side walls, although four, six or other common “nut” like combinations may be employed.

As more clearly seen in FIG. 3, the head member 25 may be formed with side walls 28 forming a recessed slot 29 sized and shaped to be engaged by socket wrench ratchet, e.g., the recessed slot 29 may be formed by four side walls 28 to engage a ½ inch socket wrench ratchet or an “Allen wrench” of similar size.

In operation, the firefighter tool 20 would be placed over the cap 10 such that slots 23 engage the pins 13 of the cap. In one embodiment, the base member 21 and side members 22 may need to be spaced such that the tool 20 accommodates any intervening members of the cap 10 such as attachment 14, which in some embodiments is an attachment for a chain (not shown) to attach the cap to the wall or other secured member, such that cap is not mis-placed and is readily available after use of the standpipe. Once the tool 20 is placed on the cap such that the pins 13 are engaged, the firefighter may readily remove the cap. In particular, the firefighter may employ a wrench to engage the head member to rotate the tool 20 and the engaged cap 10. The wrench may engage the side walls 26 or a socket wrench may be employed to engage the recessed slot 29. In situations in which the standpipe offers little freedom of motion for a wrench, a socket wrench ratchet allows ease of use the tool and efficient removal of the cap as a result of the ease of engagement of the pins 13 and range of motion offered by the tool even in connection with a standpipe disposed within a recessed cabinet.

It will be recognized that the firefighter tool 20 will engage the pins 13 even when the cap is positioned such that the pins 13 are positioned to prevent easy access by conventional firefighter tools such as a spanner wrench.

While the foregoing description represents a preferred embodiment of the invention, many modifications and variations of the present invention are possible in light of the teachings herein. Thus, it is to be understood that, within the scope of the appended claims, the invention may be practiced otherwise than is specifically described above.

We claim:

1. A firefighter's tool for removing a pipe cap having pins, comprising:
a base;
at least two sides members extending from the base;
each side member forming a slot at the end distal from the base for engaging the pipe cap pins; and
the base forming a head member to be cooperatively engaged by a wrench.

2. A firefighter's tool according to claim 1, wherein the base forming a head member forms a slot to be cooperatively engaged by the male end of socket wrench.

3. A firefighter's tool according to claim 1, wherein the head member forms a slot to be cooperatively engaged by a lever for turning the firefighter's tool.

4. A firefighter's tool for removing a pipe cap having pins, comprising:
a cylindrical base, one end of which forms at least two slots circumferentially arranged about the base end for engaging the pins of the cap; and
the other end of the base forming a head member to be cooperatively engaged by a wrench.

5. A firefighter's tool according to claim 4, wherein the head member forms a slot to be cooperatively engaged by the male end of a socket wrench.

6. A firefighter's tool according to claim 4, wherein the head member forms a slot to be cooperatively engaged by a lever for turning the firefighter's tool.

7. A firefighter's tool according to claim 1, wherein the base forming a head member comprises at least four sides.

8. A firefighter's tool according to claim 1, wherein the slot of the head member includes at least four sides.

9. A firefighter's tool according to claim 4, wherein the head member includes at least four sides.

10. A firefighter's tool according to claim 4, wherein the slot of the head member includes at least four sides.
